(19) United States
(12) Patent Application Publication
(10) Pub. No.: US 2024/0300468 A1
(43) Pub. Date: Sep. 12, 2024

(54) APPARATUS FOR COLLECTING AND FORWARDING SENSOR SIGNALS, ELECTRONIC BRAKING SYSTEM, TELEMATICS SYSTEM AND METHOD FOR OPERATING THE APPARATUS

(71) Applicant: ZF CV Systems Global GmbH, Bern (CH)

(72) Inventors: Philipp Lang, Luebeck (DE); Alexander Rodenberg, Braunschweig (DE); Axel Stender, Hameln (DE); Oliver Topic, Hannover (DE); Jan-Christoph von der Beeke, Algermissen (DE)

(21) Appl. No.: 18/664,008

(22) Filed: May 14, 2024

Related U.S. Application Data
(63) Continuation of application No. PCT/EP2022/081189, filed on Nov. 9, 2022.

(30) Foreign Application Priority Data
Nov. 24, 2021 (DE) 10 2021 130 771.6

(51) Int. Cl. B60T 17/22; B60T 8/52

(52) U.S. Cl. CPC B60T 17/22; B60T 8/52; B60T 2240/00; B60T 2260/08

(57) ABSTRACT

An apparatus for collecting and forwarding sensor signals for vehicles with sensors for monitoring wheel ends, with at least two inputs for sensor signals and at least one output interface for digital signals. The output interface can, for example, be a radio device and the apparatus can include a receiver for radio signals from tire pressure sensors. A method is for operating such an apparatus and includes transferring sensor signal dependent digital signals to the at least one output interface.

### CROSS-REFERENCE TO RELATED APPLICATIONS

This application is a continuation application of international patent application PCT/EP2022/081189, filed Nov. 9, 2022, designating the United States and claiming priority from German application 10 2021 130 771.6, filed Nov. 24, 2021, and the entire content of both applications is incorporated herein by reference.

### TECHNICAL FIELD

The disclosure relates to an apparatus for collecting and forwarding sensor signals for vehicles with sensors for monitoring wheel ends. In addition, the disclosure relates to an electronic braking system, a telematics system, a vehicle and a method of operating the apparatus.

### BACKGROUND

Vehicles, especially commercial vehicles, may have sensors for monitoring wheel ends. A wheel end is an area at the end of an axle of a vehicle that contains wheels, brakes and bearings. The sensors preferably monitor brake pad wear, braking torque, a temperature of a brake disc or brake drum, a temperature of a wheel bearing and/or vibrations on the wheel end and generate analog sensor signals. Usually, electronic control units in motor vehicles or trailers are equipped with only a few analogue inputs for sensors. Therefore, not all of the above-mentioned sensors can be connected to a selected control unit. The control unit would have to be expanded with additional analogue inputs, which seems unacceptable for cost reasons.

These control units may be connected to a vehicle bus, in particular to a CAN bus or LIN bus. Alternatively or additionally, the control units may have a transmitting and receiving device for wireless communication, for example as part of a telematics system.

### SUMMARY

It is an object of the present disclosure to provide a solution for connecting the sensors to at least one control unit without the need to expand the control unit in terms of equipment.

According to the disclosure, the object is, for example, achieved via an apparatus for collecting and forwarding sensor signals for vehicles with sensors for monitoring wheel ends has at least two inputs for sensor signals and at least one output interface for digital signals. The sensors of the wheel ends can be connected to the inputs of the apparatus. Within the apparatus, the signals are digitized and output via the output interface. The apparatus can be used to bundle and forward signals from multiple sensors. The apparatus can be located close to an axle or to the wheel ends of axles, so that significantly less cabling is required overall from the sensors to the control unit. Analog signals can also be less disturbed due to a shorter cable length. The transfer of the sensor signals from the apparatus to the control units can be carried out via known, standardized interfaces.

According to another aspect of the disclosure, the inputs include analog inputs. This eliminates the need for an analogue-to-digital conversion upstream of to the inputs. The conversion takes place in the apparatus.

According to another aspect of the disclosure, the inputs include digital inputs. The signals are already provided as digital signals. This eliminates the need to convert them into digital signals within the apparatus.

The inputs can be analog inputs only, digital inputs only, or may include both types of inputs and support voltage-modulated or current-modulated signals or both types of signals.

According to another aspect of the disclosure, the inputs include the inputs for a power supply for sensors. The apparatus provides electrical energy via the inputs for operating the sensors, preferably 5 volts supply voltage, while the sensors provide a signal voltage of 0.5 to 4.5 volts in particular.

According to another aspect of the disclosure, the output interface is suitable for connection to a vehicle bus. The technology required for this is well known and widespread. Vehicles typically have a CAN bus or LIN bus. Preferably, the output interface is suitable for connection to a CAN bus, in particular according to ISO 11898-2:2016, or a LIN bus, in particular according to ISO 17987-4:2016. Preferably, a cable of the vehicle bus for connection to the output interface contains a power supply for the apparatus. This can also be used to supply the sensors with electrical energy.

According to another aspect of the disclosure, the output interface can be a radio device. Output signals are then transmitted wirelessly to a radio-enabled control unit. The radio device may be provided as an output interface as an alternative to or in addition to a digital output interface.

According to another aspect of the disclosure, the apparatus can have a receiver for radio signals from tire pressure sensors. The radio transmission of the signals from tire pressure sensors is well known and widespread. Central receivers for the radio signals are common. In the case of multi-axle vehicles, the signal strength may no longer be sufficient due to the distance from the central receiver. Significantly more favorable for reception is the arrangement of the apparatus according to the disclosure on each axle or on each wheel end. The tire pressure sensor signals recorded by the receiver in the apparatus are transmitted to the respective control unit via the output interface. In addition, a transmitter can be assigned to the receiver in the apparatus, wherein the transmitter and receiver in combination as a so-called repeater amplify the tire pressure sensor signals and thus forward them to a receiver that is already provided.

According to another aspect of the disclosure, the apparatus can have a power supply via the output interface. An additional power supply is then not required.

According to another aspect of the disclosure, the apparatus can have a power supply with batteries. These are preferably installed in the apparatus and are interchangeable or rechargeable. This variant is preferably provided in conjunction with the output interface in the form of a radio device.

According to another aspect of the disclosure, the apparatus can have a power supply by obtaining energy from the environment. For example, piezo actuators can convert the vibrations that occur during the operation of a vehicle into electrical energy. A buffer storage device can be provided for the temporary storage of the electrical energy.

According to another aspect of the disclosure, the apparatus can be in the form of a completely closed box, at least with inputs accessible from the outside. This ensures trouble-free operation for as long as possible.

According to another aspect of the disclosure, the apparatus can have at least one output interface accessible from the outside. Alternatively, the output interface is a radio device inside the apparatus and not accessible from the outside.

According to a further aspect of the disclosure, at least in each case an input for signals of a temperature sensor, an input for signals of a brake pad wear sensor, an input for signals of a brake torque sensor is provided. Preferably, two inputs are provided for signals from temperature sensors. In particular, these are signals of a temperature sensor on a brake and signals of a sensor on a wheel bearing. With the apparatus of this form, the most important sensors of a wheel end can be bundled and forwarded. The inputs can be analog only, digital only, or partly analog and partly digital.

According to another aspect of the disclosure, at least four inputs for signals from temperature sensors, two inputs for signals from brake pad wear sensors, two inputs for signals from brake torque sensors are provided. The apparatus in such a form is suitable for receiving and forwarding the sensors of an axle or of two wheel ends.

According to a further aspect of the disclosure, a processing unit can be provided, also for the preprocessing of the sensor signals. In addition to bundling and providing the sensor signals, the processing unit within the apparatus can also undertake their preprocessing, such as the evaluation of a bridge circuit of a strain gauge. Sensor signals are then electrical voltages of the bridge circuit.

An electronic braking system configured according to the disclosure with a control unit for vehicles with sensors for monitoring wheel ends has at least one apparatus according to the disclosure. The braking system does not require a new control unit, despite processing several different sensor signals.

According to a further aspect of the disclosure, the control unit in the electronic braking system can be connected to at least one of the apparatuses according to the disclosure via a vehicle bus. The connection via the vehicle bus uses existing interfaces. A special adaptation of the control unit to the apparatus according to the disclosure is not required.

Advantageously, the vehicle bus is a CAN bus or LIN bus. In particular, when communicating via a CAN bus, the connected apparatus according to the disclosure may have a switchable terminating resistance for termination.

According to a further aspect of the disclosure, the control unit in the electronic braking system can have a receiver for the reception of radio signals of the apparatus according to the disclosure. The apparatus according to the disclosure has a corresponding transmitter for this purpose. Preferably, in addition to the receiver, there is also a transmitter in the control unit for communication with the apparatus according to the disclosure.

Advantageously, temperature sensors, brake pad wear sensors and/or brake torque sensors are components of the braking system.

A telematics system developed according to the disclosure may have the same previously mentioned features as the electronic braking system, that is, a control unit with an apparatus according to the disclosure and optionally with the other features listed. The control unit may include a telematics function for communication with external receivers/transmitters. However, the telematics function can also be outsourced to a telematics device connected to the control unit. With the telematics system, sensor data can be sent to external receivers/transmitters.

A subject matter of the disclosure is also a vehicle with an electronic braking system or telematics system according to the disclosure. The sensor signals generated in the vehicle can be transmitted easily and cost-effectively to the control unit of the braking system or telematics system.

A subject matter of the disclosure is also a method for the operation of the apparatus according to the disclosure, wherein sensor-signal-dependent digital signals are forwarded to the output interface. Part of the method is therefore the transfer of digital signals to the output interface, wherein these digital signals are dependent on the received sensor signals. The digital signals can be formed from the analog sensor signals by analog-to-digital conversion. The digital signals can also be modified or processed.

According to a further aspect of the disclosure, additional signals dependent on the installation location can be forwarded to the output interface. The digital signals preferably contain additional information about the installation location of the apparatus, such as on which axle and/or on which wheel end the apparatus is arranged and connected to the sensors present there.

According to another aspect of the disclosure, sensor type-dependent signals can also be forwarded to the output interface. The signals then contain clear indications as to whether a temperature at the wheel bearing, a temperature in the brake, a braking torque or an adjustment range are measured and forwarded as a measure of brake wear.

According to another aspect of the disclosure, a preprocessing of sensor signals can take place in the apparatus. In particular, the preprocessing includes:
analogue preprocessing of analogue signals,
digital preprocessing of incoming digital signals,
digital preprocessing of converted analog signals, with or without preprocessing of the latter.

An example of analog preprocessing is the evaluation of a bridge circuit of a strain gauge.

### BRIEF DESCRIPTION OF DRAWINGS

The invention will now be described with reference to the drawings wherein:

FIG. 1 is a schematic representation of a vehicle;

FIG. 2 shows a circuit diagram with an apparatus for collecting and forwarding sensor signals, with a CAN bus and a control unit;

FIG. 3 shows a variant of the version shown in FIG. 2;

FIG. 4 shows a variant of the apparatus for collecting and forwarding sensor signals; and,

FIG. 5 shows a schematic representation of details of a variant of the apparatus for collecting and forwarding sensor signals.

### DETAILED DESCRIPTION

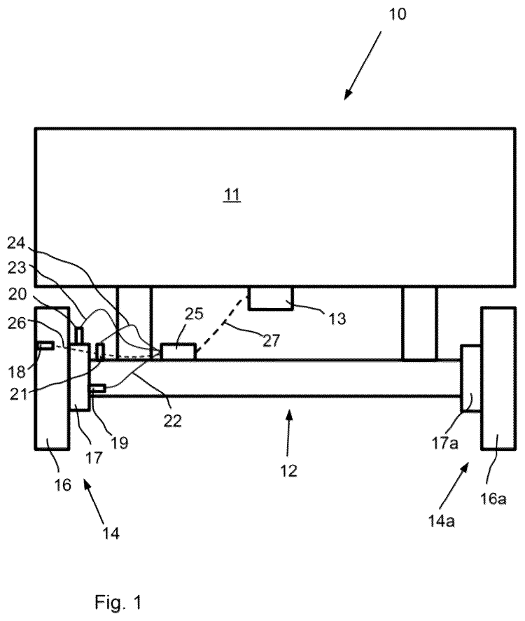

Reference is first made to FIG. 1. A vehicle 10 with a body 11 and an axle 12 is shown. Other axles are provided, but not visible. The vehicle 10 is a motor vehicle or a trailer. An electronic control unit 13, which is preferably a brake control unit or a telematics control unit, is arranged on the body 11.

The axle 12 has wheel ends 14, 15 with wheels 16 and brakes 17. Further details, which are also present on the wheel end 15 are only drawn on the wheel end 14. These are a tire pressure sensor 18 in the wheel 16, a brake pad wear sensor 19 and a temperature sensor 20 on the brake 17, as well as a brake torque sensor 21. In addition or alternatively, additional sensors may be provided, such as a temperature sensor for a wheel bearing that is not shown.

The sensors 19, 20, 21 are connected to a signal conditioning apparatus 25 via cables 22, 23, 24. This is an apparatus for collecting and forwarding sensor signals and has certain inputs, output interfaces and properties for this purpose. The tire pressure sensor 18 is connected to the signal conditioning apparatus 25 via a radio connection 26.

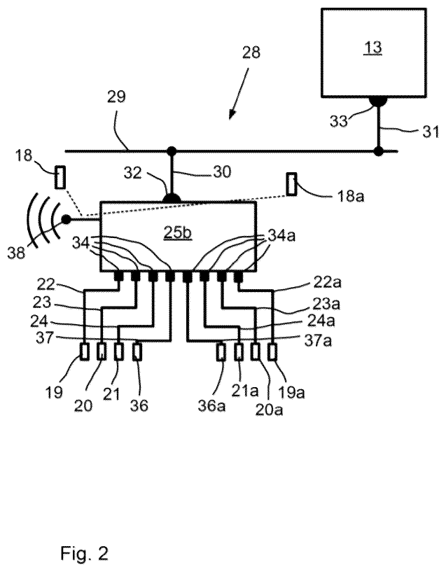

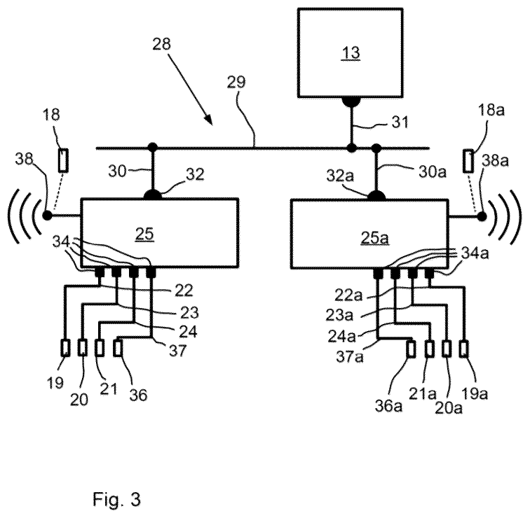

The signal conditioning apparatus 25 is connected to the control unit 13, either by a radio connection 27 or by a cable arrangement 28 not shown in FIG. 1, see FIGS. 2 and 3.

The cable arrangement 28 preferably contains a CAN bus 29 to which the control unit 13 and the signal conditioning apparatus 25 are connected via stub lines 30, 31. For this purpose, the control unit 13 and the signal conditioning apparatus 25 have suitable output interfaces 32, 33. At least the output interface 33 of the control unit 13 is also an interface for incoming signals. The output interfaces 32, 33 are digital interfaces.

The signal conditioning apparatus 25b shown in FIG. 2 is provided and equipped for collecting and forwarding sensor signals from both wheel ends 14, 15. Accordingly, two times four analogue inputs are provided, namely inputs 34 for signals of the sensors 19, 20, 21 with the cables 22, 23, 24 and another temperature sensor 36 with cable 37 of the wheel end 14 and inputs 34a for signals from sensors 19a, 20a, 21a, 36a with cables 22a, 23a, 24a, 37a of the other wheel end 14a. In addition, the signal conditioning apparatus 25 is provided with an antenna 38 for receiving radio signals of the tire pressure sensor 18 at the wheel end 14 and radio signals of a tire pressure sensor 18a at the other wheel end 14a.

With the signal conditioning apparatus 25b shown in FIG. 2, the signals from all sensors 18, 19, 20, 21, 36, 18a, 19a, 20a, 21a, 36a can be received and made available to the control unit 13 via the cable arrangement 28, that is, sensor signals from both wheel ends 14, 14a. The number of inputs 34, 34a is matched to this.

In the embodiment of FIG. 3, two signal conditioning apparatuses 25, 25a are provided in accordance with FIG. 1, namely one for each wheel end 14, 14a. Both signal conditioning apparatuses 25, 25a are connected to the control unit 13 via the cable arrangement 28 and thus provide the mentioned sensor signals. The control unit 13 itself only requires a uniform interface for the different sensor signals, namely the output interface 33 for connection to the cable arrangement 28 or the CAN bus 29. Due to the division into two signal conditioning apparatuses 25, 25a as provided for in FIG. 3, these can be arranged closer to the wheel ends 14, 14a. This allows for shorter cable connections and shorter radio connections to corresponding sensors, see in particular sensors 18, 18a and antennas 38, 38a.

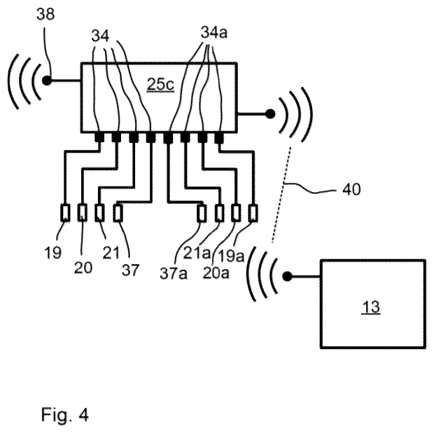

As in FIG. 2, the signal conditioning apparatus 25c shown in FIG. 4 is equipped with two times four inputs 34, 34a, but is additionally connected to the control unit 13 via a radio connection 40. This eliminates the need for an externally accessible and visible output interface on the signal conditioning apparatus 25c.

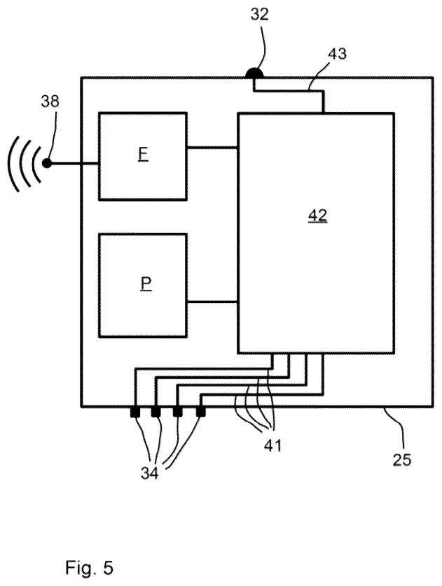

On the basis of the embodiment in FIG. 5, the structure and properties of the signal conditioning apparatus 25 and modifications thereto are explained below. The explanatory notes also apply to signal conditioning apparatuses 25a, 25b, 25c, unless otherwise indicated.

As in FIGS. 1 and 3, the signal conditioning apparatus 25 is provided here for the reception and processing of sensor signals of the wheel end 14 and accordingly has the inputs 34, which are internally connected to a processing unit 42 via cables 41. From this, a cable 43 leads to the output interface 32.

Within the signal conditioning apparatus 25, a power supply P is optionally provided, which supplies the processing unit 42 with electrical energy. The power supply P can be a long-life battery, a rechargeable battery or an energy harvesting device. Energy generation is possible, for example, by piezo actuators that convert vibrations into electrical voltage. Alternatively or in addition to the power supply P, the processing unit 42 can be supplied with electrical energy via the output interface 32.

The optional radio apparatus F is also connected to the processing unit 42 and can have very different characteristics and functions. Preferably, the radio apparatus F receives the signals of the tire pressure sensor 18 and transmits them to the processing unit 42. Alternatively, the radio apparatus F can contain a transmitter in addition to a receiver and, as a so-called repeater, can amplify the radio signals of the tire pressure sensor 18 and forward them to a receiver of such signals, which is provided anyway but not depicted.

The radio apparatus F can alternatively or additionally provide a radio connection 40 for the connection of the signal conditioning apparatus 25c to the control unit 13, as shown in FIG. 4. The control unit 13 is then equipped with a transmitter/receiver that is not shown.

The processing unit 42 converts the analog signals present at the inputs 34 into digital signals and makes them available at the output interface 32. If the radio apparatus F receives signals of a tire pressure sensor, these signals are also provided at the output interface 32 and, if necessary, digitized or otherwise converted beforehand. Analog or digital preprocessing of the signals can also be carried out in the processing unit 42 before the analogue signals are digitized and/or before the digital signals are transferred to the output interface 32, 32a.

The signals output via the output interface 32 preferably contain not only the digital values of the analog signals present at the inputs 34. Further information may be linked to the digital signals, for example about the respective sensor 18, 19, 20, 21, 36, 18a, 19a, 20a, 21a, 36a and/or about the installation location, preferably the axle 12 and/or the respective wheel end 14, 14a. This allows the control unit 13 to accurately assign the incoming digital signals.

The digital signals at the output interface 32 are formatted as CAN messages. Instead of the CAN bus 29, a LIN bus or other vehicle bus can also be provided. The preparation and formatting of the signals must be adapted accordingly.

The signal conditioning apparatuses 25, 25a, 25b, 25c (FIGS. 1, 3, 5) are in particular closed boxes. Only the inputs 34 and the output interface 32 are externally visible and accessible. The inputs 34a and the output interface 32a are visible and accessible on the signal conditioning apparatus 25a (FIG. 3), the inputs 34, 34a and the output interface 32 on the signal conditioning apparatus 25b (FIG. 2), and only the inputs 34, 34a on the signal conditioning apparatus 25c (FIG. 4).

The inputs 34, 34a or some of them can also be implemented as digital inputs. The inputs can be used to provide a supply voltage for sensors, especially 5 volts.

It is understood that the foregoing description is that of the preferred embodiments of the invention and that various changes and modifications may be made thereto without departing from the spirit and scope of the invention as defined in the appended claims.

### REFERENCE SIGN LIST (PART OF THE DESCRIPTION)

10 Vehicle
11 Structure
12 Axle
13 Control unit
14 Wheel end
14a Wheel end
16 Wheel
16a Wheel
17 Brake
17a Brake
18 Tire pressure sensor
18a Tire Pressure Sensor
19 Brake Pad Wear Sensor
19a Brake Pad Wear Sensor
20 Temperature sensor
20a Temperature sensor
21 Brake Torque Sensor
21a Brake Torque Sensor
22 Cable
22a Cable
23 Cable
23a Cable
24 Cable
24a Cable
25 Signal conditioning apparatus
25a Signal conditioning apparatus
25b Signal conditioning apparatus
25c Signal conditioning apparatus
26 Radio Connection
26a Radio Connection
27 Radio Connection
28 Cable arrangement
29 CAN bus
30 Stub line
31 Stub line
32 Output Interface
32a Output Interface
34 Inputs
34a Inputs
36 Sensor
36a Sensor
37 Cable
37a Cable
38 Antenna
38a Antenna
40 Radio Connection
41 Cables
42 Processing unit
43 Cable
F Radio apparatus
P Power supply

1. An apparatus for collecting and forwarding sensor signals for vehicles with sensors for monitoring wheel ends, the apparatus comprising:
at least two inputs for sensor signals; and,
at least one output interface for digital signals.

2. The apparatus of claim 1, wherein said at least two inputs include analog inputs.

3. The apparatus of claim 1, wherein said at least two inputs include digital inputs.

4. The apparatus of claim 1, wherein the at least two inputs include a power supply for the sensors.

5. The apparatus of claim 1, wherein said at least one output interface is suitable for connection to a vehicle bus.

6. The apparatus of claim 5, wherein said at least one output interface is suitable for connection to a CAN bus or LIN bus.

7. The apparatus of claim 1, wherein said at least one output interface is a radio device.

8. The apparatus of claim 1 further comprising a receiver for radio signals from tire pressure sensors.

9. The apparatus of claim 1 further comprising a repeater for radio signals from tire pressure sensors.

10. The apparatus of claim 1 further comprising a power supply via the at least one output interface.

11. The apparatus of claim 1 further comprising a power supply with batteries.

12. The apparatus of claim 1 further comprising a power supply configured to obtain energy from an environment.

13. The apparatus of claim 1 further comprising a housing formed as a fully enclosed box wherein said at least two inputs are accessible from outside said box.

14. The apparatus of claim 13, wherein said at least one output interface is externally accessible.

15. The apparatus of claim 1, wherein said at least two inputs include:
an input for signals of a temperature sensor;
an input for signals of a brake pad wear sensor; and,
an input for signals of a brake torque sensor.

16. The apparatus of claim 1, wherein said at least two inputs include:
at least four inputs for signals from temperature sensors;
at least two inputs for signals from brake pad wear sensors; and,
at least two inputs for signals from brake torque sensors.

17. The apparatus of claim 1 further comprising a processing unit configured to preprocess the sensor signals.

18. An electronic braking system comprising:
a control unit for vehicles with sensors for monitoring wheel ends;
an apparatus having at least two inputs for sensor signals; and,
said apparatus further having at least one output interface for digital signals.

19. The electronic braking system of claim 18, wherein said control unit is connected to said apparatus via a vehicle bus.

20. The electronic braking system of claim 19, wherein the vehicle bus is a CAN bus or LIN bus.

21. The electronic braking system of claim 18, wherein said at least one output interface is a radio device; and, said control unit has a receiver for receiving radio signals of said radio device of said apparatus.

22. A telematics system comprising:
a control unit for vehicles with sensors for monitoring wheel ends; and,
the apparatus of claim 1.

23. The telematics system of claim 22, wherein said control unit is connected to said apparatus via a vehicle bus.

24. The telematics system of claim 23, wherein the vehicle bus is a CAN bus or LIN bus.

25. The telematics system of claim 22, wherein said at least one output interface is a radio device; and, said control unit has a receiver for receiving radio signals of said radio device of said apparatus.

26. A vehicle comprising the electronic braking system of claim 18.

27. A vehicle comprising the telematics system of claim 22.

28. A method for operating an apparatus for collecting and forwarding sensor signals for vehicles with sensors for monitoring wheel ends, the apparatus comprising: at least two inputs for sensor signals; and, at least one output interface for digital signals, the method comprising:
transferring sensor signal dependent digital signals to the at least one output interface.

29. The method as claimed in claim 28, characterized in that additional installation location dependent signals are transferred to the at least one output interface.

30. The method of claim 28, wherein additional sensor type dependent signals are transferred to the at least one output interface.

31. The method of claim 28 further comprising preprocessing sensor signals in the apparatus.
